(19) United States
(12) Patent Application Publication
(10) Pub. No.: US 2010/0050894 A1
(43) Pub. Date: Mar. 4, 2010

(54) Printed Matter and Method for Manufacturing Printed Matter

(75) Inventors: Hiroyuki Miura, Tokyo (JP); Junichi Kaminaga, Tokyo (JP); Takeshi Ikeda, Tokyo (JP); Yuji Kubo, Tokyo (JP); Eishi Aoki, Tokyo (JP)

Correspondence Address: SQUIRE, SANDERS & DEMPSEY L.L.P., 1 MARITIME PLAZA, SUITE 300, SAN FRANCISCO, CA, 94111, US

(73) Assignee: Toppan Printing Co., Ltd., Tokyo (JP)

(21) Appl. No.: 12/617,623

(22) Filed: Nov. 12, 2009

Related U.S. Application Data
(63) Continuation of application No. PCT/JP2007/063169, filed on Jun. 29, 2007.

(51) Int. Cl. B41N 1/00

(52) U.S. Cl. 101/462

(57) ABSTRACT

A printed matter includes a substrate, a partition wall sectioning a surface of the substrate into a number of areas and an ink film formed in an aperture part of the partition wall by an ink jet apparatus wherein the partition wall has an ink repellent property material including a resin constituent and an ink repellent constituent and the ink repellent constituent is a compound which has a structure having an ink repellent property and a structure compatible with the resin constituent and wherein a surface roughness of the partition wall is 20-300 angstrom.

### CROSS REFERENCE TO RELATED APPLICATION

This application is a continuation of PCT International Application No. PCT/JP2007/63169, the entire disclosure of which is incorporated herein by reference.

### BACKGROUND OF THE INVENTION

1. Field of the Invention

The present invention is related to a printed matter manufactured by an ink jet apparatus. An example of the printed matter is a color filter. A color layer of the color filter is formed by an ink jet printing apparatus. Another example of the printed matter is an organic electroluminescence element. An organic luminous layer of the organic electroluminescence element is formed by an ink jet apparatus. In addition to the above, a circuit board, a thin film transistor, a microlens, a biotip or the like can also be an example of the printed matter.

2. Description of the Related Art

For example, various methods have been studied as a method for forming the color layer of the color filter so far. As a representative method, a photolithographic method and an ink jet method are known. When the pixel pattern of the color filter is formed by a photolithographic method, a coated film of a photosensitive resin layer of each color is formed on the entire surface of a substrate. After the coated film is exposed to form a pattern, unnecessary parts of the coated film are removed and the remaining pattern becomes pixels. In this method, since a large part of the coated film is developed and removed, a large amount of material goes to waste. In addition, the number of steps increases, because exposure and developing are performed for each pixel. The photolithographic method is not used only for a method of manufacturing a color filter, but also for a method of manufacturing various optical elements and electrical elements such as an electroluminescence element. When the substrate is large, the above mentioned problem of the photolithographic method becomes significant, and there are also cost and environmental problems. As a method for solving these problems, a method for manufacturing an optical element by an ink jet method has recently attracted attention. For example, when a color filter is manufactured by an ink jet method, resin compositions of RGB three colors are used as inks and respective colors can be printed in one process at the same time. Therefore, an ink material such as a pigment does not go to waste. Moreover, the burden on the environment is reduced, and cost is significantly reduced, because pixels of three colors can be simultaneously and efficiently formed.

As mentioned above, an ink jet method is applied to the manufacturing of an optical element such as a color filter and an electroluminescence element, because an ink jet method can shorten the manufacturing process and reduce cost significantly. However, there are problems in the ink jet method such as “flatness of a color ink layer”, “a mixed color” and “dropouts”. The case of manufacturing a color filter is explained below as an example.

In the problem “flatness of a color ink layer”, the film thickness of a color layer printed by an ink jet method does not have a flat structure, instead it has a convex shape where the film thickness of the center is thicker than that of the edge. Therefore, the shape of respective pixels of a color filter has irregularity. Thus, defects called “dropouts”, which will be described later, occur in the edge of the layer having a thin layer thickness, and a problem of color variability caused by differences in chromaticity occurs. Then, the above problems cause defects in quality of an image display apparatus manufactured by the ink jet method.

“Dropouts” are defects mainly caused when an applied ink cannot be scattered sufficiently and uniformly in an area sectioned by a partition wall. In addition, “dropouts” may cause defects in a display such as color variability and reduction in contrast. When an ink repellent material leaks from the surface of the partition wall, dropouts occur. A leak of the ink repellent material form the surface of the partition wall can be accelerated by heating. When the partition wall is formed by a photolithographic method, after a resin composition of the partition wall is applied to a substrate and the substrate is exposed and developed using a mask, the partition wall is post-baked. At this time, dropouts occur, because the ink repellent material leaks from one part of the partition wall and the ink discharged from the ink jet apparatus can not be spread. Furthermore, when a photosensitive resin composition including an ink repellent material is applied to a substrate and a partition wall is formed by exposure and developing the resin composition, the ink repellent material located in an aperture part of the partition wall can not be sufficiently removed by a developer and the ink repellent material remains inside the pixels. Dropouts also occur in the above mentioned case.

“A mixed color” is a defect where color inks having different colors are mixed between adjacent pixels. A mixed color occurs when the discharged ink overflows and exceeds the partition wall. A method disclosed in patent documents 1-4 are proposed to solve this problem as a method for manufacturing a color filter substrate using an ink jet method. In patent documents 1-4, to prevent an ink bleed and a mixed color of inks in the ink jet process, a black resin layer including an ink repellent material such as a fluorine compound is formed as the partition wall by a photolithographic method.

The representative method for manufacturing an optical element using an ink jet apparatus is explained below according to the patent documents 1-4. The patent documents 1-4 disclose a method in which a fluorine compound is used as an ink repellent material for a partition wall of a color filter manufactured by an ink jet method. In this method, although a mixed color caused by an ink jet method can be prevented, a color ink layer is not uniform due to the surface roughness. Although a pigment concentration is lowered to make the color ink layer more uniform, a color filter having a low contrast is formed due to the insufficient light blocking effects of a light blocking layer.

The present invention is carried out to solve the above mentioned problem. The present invention provides a printed matter having high quality and high reliability where mixed color and dropouts are prevented, and the uniformity of pixels of a color ink layer is excellent when the printed matter is manufactured by an easy process at a low cost using an ink jet method.

Patent Document 1: Japanese laid open patent application No. H6-347637

Patent Document 2: Japanese laid open patent application No. H7-35915

Patent Document 3: Japanese laid open patent application No. H7-35916

Patent Document 4: Japanese laid open patent application No. H7-35917

### SUMMARY OF THE INVENTION

One embodiment of the present invention is a printed matter which includes a substrate, a partition wall sectioning a surface of the substrate into a number of areas and an ink film formed in an aperture part of the partition wall by an ink jet apparatus wherein the partition wall has an ink repellent material including a resin constituent and an ink repellent constituent, and the ink repellent constituent is a compound which has a structure having an ink repellent property and a structure compatible with the resin constituent and wherein a surface roughness of the partition wall is 20-300 angstrom.

### DETAILED DESCRIPTION OF THE INVENTION

The preferred embodiment of the present invention is explained below. An example of a printed matter of the present invention is an optical component which forms a display screen image of an image display. A number of areas of this optical element correspond to pixels which form the display screen image. In this optical element, a partition wall can have a light blocking layer function by including a black color blocking component. By arranging the light blocking layer, the contrast of the optical element is improved. As an optical component, a color filter which forms a display screen image of a color liquid crystal display can be exemplified. In this case, an ink film forms a color layer which colors transmitted light and the color layer has multi-colors which have different colors in the respective areas. In addition, an example of an optical component is an organic electroluminescence element. In this case, an ink film forms an organic luminous material layer. Moreover, the organic luminous material layer has multi-colors which have different colors in the respective areas. In addition to an optical component, a circuit board, a thin film transistor, a microlens, a biotip or the like can be examples of a printed matter of the present invention. A color filter is mainly exemplified below.

A substrate of the present invention is used as a support substrate of a printed matter. In the case of a color filter or an organic electroluminescence element, a heretofore known transparent substrate material such as a glass substrate, a quartz substrate, a plastic substrate or a metal plate can be used as a substrate. Among the above, the glass substrate is superior in terms of transparency, intensity, heat resistance and weather resistance.

A partition wall of the present invention sections the surface of a substrate into multiple areas and also has the function of preventing a mixed color of an ink printed on the respective multiple areas. In the present invention, by making the surface roughness of the partition wall equal to or less than 300 angstrom, uniformity of a color ink layer becomes favorable and a mixed color of inks and dropouts can be prevented. In other words, in the prior arts, when a color filter, an organic electroluminescence element or the like is formed by an ink jet method, the surface roughness of the partition wall is more than 300 angstrom and the surface becomes rough. This is caused by an aggregation of a resin constituent, an ink repellent constituent, a pigment or an additive. Therefore, the color ink discharged into an aperture part of the partition wall develops a strong tendency to be rejected by the surface of the partition wall and a color pixel has a convex shape. In other words, the flatness of a pixel is poor. In addition, there is a problem of escalated dropouts, because an ink on the surface of the partition wall can easily be rejected. Then, the present invention can solve this problem by forming the surface roughness of the partition wall equal to or less than 300 angstrom. As a particular method for forming the surface roughness of the partition wall equal to or less than 300 angstrom, a polishing process, an ultraviolet ozone process, an excimer laser process, an electric corona process, an oxygen plasma process, a warm air process in which a dryer or the like is used and a chemical process in which a developer or a solvent is used can be exemplified. However, the method is not limited to these processes as long as the predetermined surface roughness can be obtained. Furthermore, when the surface roughness of the partition wall is less than 20 angstrom, a problem of a mixed color may occur, because an ink repellent property of the partition wall decreases. In addition, there may be a problem in that the adhesion between the substrate and the partition wall becomes poor, because surface reflectance is increased. Therefore, the surface roughness of the partition wall is preferably equal to or more than 20 angstrom, more preferably, equal to or more than 50 angstrom. In addition, an optical property of a color filter or an organic electroluminescence element becomes excellent when an optical concentration of the partition wall is adjusted to 3.0-6.0 in the present invention. If the optical concentration is equal to or less than 3.0, the light blocking effect is insufficient, which leads to a decrease in contrast. On the other hand, if the optical concentration of the partition wall is equal to or more than 6.0, there may be a problem in that linearity becomes poor, because only the top surface of the partition wall becomes hardened. Moreover, when a printed matter is an optical component which forms a display screen image of a display, the contrast of the display screen image can be improved by including a light blocking effect in the partition wall. A resin composition which forms the partition wall includes a resin constituent and an ink repellent constituent as essential components in each case. A resin constituent is a resin composition which is generally called a binder resin or the like. The partition wall is adhered and fixed to the substrate by the resin constituent, and the resin constituent provides an ink resistance property to the partition wall. As the resin constituent, a resin containing amino group, amide group, carboxyl group, hydroxyl group or carboxylic acid group is preferably used. Specifically, cresol-novolac resin, polyvinyl phenol resin, acryl resin, methacryl resin, cardo resin, epoxy resin, polyimide resin, melamine resin or the like can be exemplified. These resin binders may be used as a single resin binder or a mixture of two or more. In addition, an ink repellent constituent provides the partition wall with an ink repellent property to repel an ink. The ink repellent constituent includes a structure compatible with the resin and a structure having an ink repellent property in a compound structure. The structure having an ink repellent property in an ink repellent constituent appears on the surface of the partition wall with time by forming the partition wall using the resin composition which includes an ink repellent constituent of a block copolymer having the above mentioned conflicting properties or by heating the resin composition of the partition wall. On the other hand, the structure compatible with a resin in the ink repellent constituent remains on the surface of the partition wall and on the inner side of the partition wall. Therefore, a mixed color and dropouts can be simultaneously prevented. As a structure having a water repellent property, fluoroalkyl group can be exemplified. More preferably, perfluoroalkyl group can be exemplified. As a part compatible with the resin, a structure part of heretofore known oleophilic polymer such as alkyl group, alkylene group and polyvinyl alcohol group can be used. As an ink repellent constituent, in addition to the above, the later mentioned fluorine compound or silicon compound can be used simultaneously. Examples of the above mentioned fluorine compound can be, in particular, vinylidene fluoride, vinyl fluoride, trifluoroethylene or the like and fluoride resin of copolymer of the above mentioned materials or the like. In addition, the fluorine compound can be used as a single material or two or more of the fluorine compounds can be mixed. Examples of the above mentioned silicon compound are silicon resin or silicon rubber, which has organic silicon on a main chain or a side chain and includes a siloxane constituent. Furthermore, the silicon compound can be used as a single material or a mixture of two or more of the silicon compounds. Moreover, the fluoride compound, silicon compound or other ink repellent constituents may also be used in combination. The ink repellent material of the present invention is contained in the resin composition preferably by 0.01% to 10% by weight. In addition, the above mentioned black light blocking material provides a light blocking effect to the partition wall and improves the contrast of a display screen image. As the black light blocking material, a black pigment, black dye, carbon black, aniline black, black lead, iron black, titanium oxide, inorganic pigment or organic pigment can be used. These black light blocking materials can be used as a single material or two or more can be mixed. Moreover, the resin component can be used after diluting with an appropriate solvent as necessary. Examples of the solvent can be, in particular, dichloromethane, dichloroethane, chloroform, acetone, cyclohexanone, ethyl acetate, 2-methoxyethanol, 2-ethoxyethanol, 2-butoxyethanol, 2-ethylethoxylacetate, 2-butoxyethylacetate, 2-methoxyethylether, 2-ethoxyethylether, 2-(2-ethoxyethoxy)ethanol, 2-(2-butoxyethoxy)ethanol, 2-(2′ethoxyethoxy) ethylacetate, 2-(2-butoxyethoxy)ethylacetate, propylene glycol monomethyl ether, propylene glycol monomethyl etheracetate, diethylene glycol dimethyl ether, tetrahydrofuran or the like. It is preferable that the amount of the solvent to be used is such that a uniform coating film with no pinholes or coating unevenness can be formed when the solvent is printed or coated on the substrate. The content ratio of the solvent is preferably controlled such that the amount of the solvent is contained in the entire weight of the resin composition by 50 to 97% by weight.

Furthermore, a weighted average aggregate diameter of the entire carbon black is 40-180 nm. In this range, the surface roughness of the partition wall can be 20-300 angstrom. Furthermore, an effect of a high OD value, prevention of irregularity of the surface roughness and excellent developing properties can be obtained. More preferably the weighted average aggregate is 50-150 nm. Particularly, it is preferred to be 60-120 nm.

In addition to the above, a compatible additive, for example, a leveling material, a chain transfer agent, a stabilization agent, a sensitizing pigment, a surface-active agent, a coupling agent or the like can be added to the resin composition. Next, the partition wall can be formed by a printing method, a photolithographic method or a transfer method using the resin composition. When the partition wall is formed by a photolithographic method, a photosensitive resin composition in which a photosensitive property is added to the resin composition can be used. Moreover, when the partition wall is formed by a printing method, the resin composition such as a thermosetting resin composition can be used.

In addition, when the surface roughness is equal to or more than 300 angstrom, the surface roughness can be controlled by a polishing process. Among apparatus which perform a polishing process which is used for finish processing, an apparatus can utilize especially a loose grain polishing in which a slurry polishing material having a fused alumina abrasive coating, a sintered alumina abrasive coating, silica system or the like is used. A polishing apparatus does not use a fixation grain polishing in which an abrasive cloth or an abrasive film is used. This is because when the loose grain polishing is utilized, a polishing material can enter into an area sectioned by the aperture parts and the partition wall and the effects of polishing selectively the upper surface and the wall surface of the partition wall can be obtained. Particularly, when a large size printed matter is manufactured, an apparatus having fluctuation in an upper press platen (for example an Oscar polishing machine) is preferably used.

### Formation of a Partition Wall by Printing Method

First, the case where the partition wall is formed by a printing method is explained below. A resin composition (or a printing material) is printed on a substrate using a printing apparatus. The printing material includes a resin constituent (a resin binder) and an ink repellent constituent (an ink repellent material) as an essential component. Furthermore, it also includes a cross-linker and a solvent. In addition, a black light-shielding material and the above mentioned additive can also be added. The surface roughness of the printing material is preferably 20-300 angstrom. When the surface roughness is more than 300 angstrom, printing becomes poor. Next, the printing material is heated at 100-250 degrees Celsius in the range of 3-60 minutes.

### Formation of a Partition Wall by a Photolithographic Method

The case where the partition wall is formed by a photolithographic method is explained below. A resin composition (a photosensitive resin composition) is applied to a substrate using a spin coater, a slit coater or the like. The photosensitive resin composition is generally divided into a positive type and a negative type. A negative type photosensitive resin composition includes a resin constituent (a resin binder), monomer, a photopolymerization initiator and the above mentioned ink repellent constituent (the ink repellent material). A positive type photosensitive resin composition includes a positive type photosensitive resin and the above mentioned ink repellent constituent. Furthermore, a cross-linker, a black light-shielding material, a pigment, a solvent and the above mentioned additive can also be added to these photosensitive resin compositions as necessary. The surface roughness of the photosensitive resin composition is preferably 20-300 angstrom. When the surface roughness is more than 300 angstrom, the applied resin composition can be affected by an asperity of the surface of the substrate.

Next, the substrate on the entire surface of which the photosensitive resin composition was applied is exposed using a mask which has a pattern of the partition wall. The substrate is developed by a developer and an unnecessary part of the photosensitive resin is removed. The partition wall is then formed on the substrate. When the surface roughness of the applied resin composition is equal to or less than 300 angstrom, the partition wall with excellent linearity can be formed after developing. Thereafter, the partition wall is heated at 100-250 degrees Celsius for about 3-60 minutes.

To optimize the surface roughness of the partition wall, the surface roughness is preferably controlled to 20-300 angstrom after the photosensitive resin composition is heated under the particular heating conditions. When the surface roughness is more than 300 angstrom, a color filter having significant color irregularity where ΔEab (color difference) of a color ink layer is equal to or more than 5 is formed when an optical material is printed by a printing apparatus. Then, the problems of a mixed color of an ink and dropouts may occur.

### Formation of an Ink Film by a Printing Apparatus

The partition wall having an ink repellent property is formed on a substrate by the above mentioned method. An ink is applied to an aperture part of the partition wall using a printing apparatus and an ink film is formed. As a printing method, a heretofore known printing method such as a relief printing method, a screen printing method, a gravure printing method and a reversal printing method can be used.

### Formation of an Ink Film by an Ink Jet Apparatus

The partition wall having an ink repellent property is formed on a substrate by the above mentioned method. An ink is discharged into an aperture part of the partition wall using an ink jet apparatus, and an ink film is thus formed. An ink jet apparatus can be classified into a piezo conversion system and a heat conversion system based on the differences in an ink discharge system. In particular, a piezo conversion system is preferable. An apparatus having an ink particulate frequency from about 5 to 100 KHz and a nozzle diameter from about 5 to 80 μm, in which a plurality of heads are arranged and a plurality of nozzles are incorporated into one single head, can be preferably used. In addition, as the ink jet apparatus, heretofore known apparatus can be used. After the ink film is formed, heating can be performed to dry and cure the solvent of the ink as necessary.

### A Photosensitive Resin Composition

As the monomer which is applied to the photosensitive resin composition, a monomer or an oligomer having vinyl group or allyl group, or molecules having vinyl group or allyl group on a terminal end or on a side chain can be used. Specifically, examples include (meth) acrylic acid and salt thereof, (meth) acrylic acid esters, (meth)acrylamides, maleic acids anhydride, maleic acid ester, itaconic acid ester, styrenes, vinyl ethers, vinyl esters, N-vinyl heterocyclic rings, allyl ethers, allyl esters, and derivatives thereof. Examples of a preferred compound are relatively low molecular weight polyfunctional acrylates such as pentaerythritol triacrylate, trimethylol propane triacrylate, pentaerythritol tetraacrylate, ditrimethylol propane tetraacrylate, and dipentaerythritol penta and hexa acrylates. The monomers may be used alone or two or more may be mixed. The amount of the monomer is contained in 100 parts by weight of the binder resin within a range from 1 to 200 parts by weight, and preferably, from 50 to 150 parts by weight.

Examples of the photopolymerization initiator include benzophenone compounds such as benzophenone, 4,4′-bis(dimethylamino)benzophenone, 4,4′-bis(diethylamino)benzophenone. Further, as the photopolymerization initiator, acetophenone derivatives such as 1-hydroxycyclohexyl acetophenone, 2,2-dimethoxy-2-phenylacetophenone, and 2-methyl-1-[4-(methylthio)phenyl]-2-morpholinopropane-1-on. Further, thioxanthone derivatives such as thioxanthone, 2,4-diethylthioxantone, 2-isopropylthioxantone, or 2-chlorothioxantone may also be used. Further, anthraquinone derivatives such as 2-methyl anthraquinone, 2-ethyl anthraquinone, 2-t-butyl anthraquinone, and chloro anthraquinone can also be used. Further, benzoin ether derivatives such as benzoin methyl ether, benzoin ethyl ether, or benzoin phenyl ether can also be used. Further, acylphosphine derivatives such as phenyl bis(2,4,6-trimethylbenzoyl)-phosphine oxide, lophine dimer such as 2-(o-chlorophenyl)-4,5-bis(4′-methylphenyl)imidazolyl dimer, N-arylglycines such as N-phenylglycine, organic azides such as 4,4′-diazide calchone, and 3,3′,4,4′-tetra(tert-butylperoxy carboxy)benzophenone, and quinone diazide group-containing compound can also be examples. The photopolymerization initiators may be used alone or two or more may be mixed together. The amount of the photopolymerization initiator can be contained in 100 parts by weight of the binder resin within a range from 0.1 to 50 parts by weight and, preferably, from 1 to 20 parts by weight.

According to the present invention, in a printed matter, especially a color filter, which includes a substrate, a partition wall which sections the surface of the substrate into a number of areas and an ink film formed on an aperture part of the partition wall, the partition wall includes a resin constituent and an ink repellent constituent. In addition, the partition wall is made of an ink repellent property material which includes the resin constituent and the ink repellent constituent. Furthermore, the ink repellent constituent is a compound which includes a structure having an ink repellent property and a structure compatible with a resin. Moreover, the surface roughness of the partition wall is 20-300 angstrom (more preferably 50-300 angstrom). By employing the above mentioned structure, the problems of “flatness of a color ink layer”, “a mixed color” and “dropouts” in the prior arts can be solved.

Moreover, according to the present invention, contrast is improved in a printed matter such as a color filter and an organic electroluminescence element, since an optical density (OD value) of the partition wall of the printed matter is 3.0-6.0.

### EXAMPLES

The surface roughness described in the following examples was measured by a Dektak 3030, and an optical density (OD value) was measured by a MacbethRP918 optical densitometer. Moreover, linearity was determined by visual contact through an optical microscope, and ΔEab was measured by a micro analyzer. Thus, an adhesion was evaluated by a tape peeling adhesive property test method according to JIS K5400 using a pressure cooker tester.

### Example 1

(Preparation of a photosensitive resin
composition for a black matrix)

| | | |
|---|---|---|
| Binder resin; V259 (manufactured by Nippon Steel | 100 | g |
| Chemical Co., Ltd) | | |
| Compound having unsaturated double bond: | 1.65 | g |
| pentaerythritol tetraacrylate | | |
| Photopolymerization initiator: oxime type | 4.95 | g |
| polymerization initiator (CGI-124 | | |
| manufactured by Ciba Speciality Chemical) | | |
| Dispersant; a commercial solution in which a black | 159 | g |
| pigment is dispersed together with a dispersant in a | | |
| solvent: EX-2906 (manufactured by Mikuni Color Co.) | | |
| Solvent; propylene glycol monoethyl ether acetate | 201 | g |
| Leveling agent: BYK-330 (manufactured by Byk-Chemi Co.) | 0.003 | g |

The constituents were mixed at the above mentioned proportions, and the photosensitive resin component was thus obtained. At this time, a weighted average aggregate diameter of a particle size of the black pigment was about 50 nm. In addition, a fluoride compound “F179” (manufactured by DIC Corporation) as an ink repellent material was added to the photosensitive resin composition at the proportion of 0.1 wt % to the total solid weight (total weight which excludes a solution weight of a solvent and dispersant in the photosensitive resin composition). Thus, the photosensitive resin composition used for a black matrix (a partition wall) was manufactured after agitating the above.

### Formation of a Black Matrix (Partition Wall)

Non-alkali glass (“#1737” manufactured by Corning Co.) was used as a substrate. The thin film of the photosensitive resin composition was coated on the entire surface of the substrate so as to have a thickness of 2.0 μm.

Then, the substrate was pre-baked. Thereafter, the substrate was exposed at 50 mJ/cm² by a super high pressure mercury lamp using a photomask having a grid-like pattern. Thus, the pattern of the partition wall of the resin composition was formed by developing with an aqueous 10% sodium carbonate solution for 30 seconds.

The substrate was placed in an oven and a heat hardening process was performed at 180 degrees Celsius for 10 minutes.

After the black matrix (the partition wall) was formed, polishing was performed for 60 seconds using a polishing material of a sintered alumina abrasive coating which had a grain diameter distribution of Φ80-120 mm by an Oscar polishing machine (polishing pressure: 10.5 g/cm², speed of an upper press platen: 25 rpm, rotation difference between the upper press platen and a lower press platen: 8 rpm, fluctuation: 10 mm). Table 1 shows the measurement results of the surface roughness of the partition wall (A), a contact angle of the color ink (B), an optical density (C) and a linearity of the partition wall (D). Since the OD (the optical density) value of the partition wall of the color filter manufactured in example 1 was excellent and a sufficient light blocking effect was obtained, it was confirmed that each result was suitable as a light blocking layer.

In addition, an OD value was obtained by the following formula while the intensity of incident light is I0 and the intensity of the transmitted light is I in the specimen of 1 μm.

OD=·log(I/I0)

(Preparation of a color ink)

| | |
|---|---|
| Methacrylic acid | 20 parts by weight |
| Methylmethacrylate | 10 parts by weight |
| Butylmethacrylate | 55 parts by weight |
| Hydroxyethyl methacrylate | 15 parts by weight |
| Butyl lactate | 300 parts by weight |

were mixed and reacted at 70° C. for 5 hours with addition of 0.75 parts by weight of azobis isobutylnitrile in a nitrogen atmosphere to obtain an acryl copolymer resin. The obtained acrylic copolymer resin was diluted with propylene glycol monomethyl ether acetate such that the resin concentration became 10% by weight to obtain a diluted solution of the acryl copolymer resin.

19.0 g of a pigment and 0.9 g of polyoxyethylene alkyl ether as a dispersant were added to 80.1 g of the diluted solution, and kneaded by three rolls to obtain each coloring varnish of red, green and blue. Pigment red 177 was used for a red pigment, pigment green 36 was used for a green pigment, and pigment blue 15 was used for a blue pigment respectively.

Propylene glycol monomethyl ether acetate was controlled and added to each of the obtained coloring varnishes respectively such that the pigment concentration became 12 to 15% by weight and the viscosity became 15 cps, to obtain color inks of red, green, and blue colors.

### (Preparation of a Color Filter)

Color inks were discharged by an inkjet apparatus having a 12 pl, 180 dpi head mounted thereon into the aperture parts of a black matrix arranged on a substrate by using color inks of red, green, and blue to form each of the color layers of red(R), green(G) and blue(B). Table 1 shows the presence or absence of the occurrence of a mixed color (E) and dropouts (F), ΔEab (G) and a ratio of contrasts (H) in the inkjet process of example 1.

### Example 2

In Example 2, a partition wall was manufactured in the same way shown in example 1.

### Formation of a PEDOT Layer

To form a positive hole transport material layer, an aqueous solution of 3,4-polyethylene dioxythiophene (PEDOT) was coated by a spin coating method on the substrate on which a transparent electrode ITO was patterned.

After the PEDOT layer was formed, polishing was performed for 30 seconds using a polishing material of a sintered alumina abrasive coating which had a grain diameter distribution of 80-120 mm by an Oscar polishing machine (polishing pressure: 10.5 g/cm2, speed of an upper press platen: 25 rpm, rotation difference between the upper press platen and a lower press platen: 8 rpm, fluctuation: 10 mm).

### Formation of an Organic Luminous Layer

A toluene solution of 1.0% by weight of polyarylene vinylene, which contains polyarylene vinylene as an organic luminous material, was prepared as a printing ink. The printing ink was printed on the aperture parts of the partition wall arranged on the substrate by using a flexographic proof press equipped with a stripe-shaped resin relief plate having a 120 μm convex portion and a 380 μm concave portion (manufactured by Matsuo Sangyo Co. Ltd.) to form an organic luminous layer. In addition to the above, as an organic luminous material, for example, an organic luminous material soluble in organic solvents such as coumarin type, perylene type, pyrane type, anthrone type, polphyrin type, quinacrydone type, N,N-dialkyl substituted quinacrydone type, naphthalimide type, N,N′-diaryl substituted pyrrolopyrrole type, and iridium complex type, such organic luminous materials dispersed in polymers such as polystyrene, polymethyl methacrylate, and polyvinyl carbazole, or high molecular organic luminous materials such as polyarylene type, polyarylene vinylene type, and polyfluolene type can be exemplified.

### Formation of an Organic Electroluminescence Element

Next, a Ca film was formed as an electron injection layer of the electrode layer of a sealing side on the organic luminescent medium layer so as to have a thickness of 5 nm. Thereafter, an Al film was formed so as to have a thickness of 100 nm by a resistance heating method as an electrode layer on the organic luminescent medium layer on which the Ca film was formed. Lastly, sealing was performed using an ultraviolet cure resin and an organic electroluminescence element was obtained. Table 1 shows the presence or absence of the occurrence of a mixed color (E) and dropouts (F) in the flexographic printing process.

### Comparative Example 1

Comparative example 1 was performed in the same way as shown in example 1, except that a weighted average aggregate diameter of a particle size of the pigment of the partition wall was 500 nm in comparative example 1.

Table 1 shows the measured result.

### Comparative Example 2

Comparative example 1 was performed in the same way as shown in example 1, except that a weighted average aggregate diameter of a particle size of the pigment of the partition wall was 500 nm in comparative example 1.

Table 1 shows the measured result.

### Reference Example 1

Reference examples 1 was performed in the same way as shown in example 1, except that a weighted average aggregate diameter of a particle size of the pigment of the partition wall was 30 nm in reference example 1. Table 1 shows the measured result.

### Reference Example 2

Reference example 2 was performed in the same way as shown in example 2, except that a weighted average aggregate diameter of a particle size of the pigment of the partition wall was 30 nm in reference example 2. Table 1 shows the measured result.

TABLE 1

| | (B) a | (C) an optical | | | | | | |
|---|---|---|---|---|---|---|---|---|
| (A) a surface | contact | density | (D) a linearity | (E) a mixed | (F) | (G) | (H) a ratio | |
| roughness (Å) | angle (°) | (OD value) | of a partition wall | color | dropouts | ΔEab | of contrasts | |
| 50 | 45 | 4.5 | excellent | absence | absence | 1 | 5000 | Example 1 |
| 500 | 45 | 7.0 | poor | presence | presence | 15 | 10000 | Comparative |
| | | | | | | | | Example 1 |
| 50 | 45 | 4.5 | excellent | absence | absence | — | 100:1 | Example 2 |
| 500 | 45 | 7.0 | poor | presence | presence | — | 300:1 | Comparative |
| | | | | | | | | Example 2 |
| 50 | 45 | 1.0 | excellent | absence | absence | 1 | 500 | Reference |
| | | | | | | | | Example 1 |
| 50 | 45 | 1.0 | excellent | absence | absence | — | 10:1 | Reference |
| | | | | | | | | Example 2 |

(The disclosure of Japanese Patent Application No. JP 2006-084854, filed on Mar. 27, 2006, is incorporated herein by reference in its entirety.)

What is claimed is:

1. A printed matter comprising:
a substrate;
a partition wall sectioning a surface of said substrate into a number of areas; and
an ink film formed in an aperture part of said partition wall, said partition wall including an ink repellent property material which has a resin constituent and an ink repellent constituent, said ink repellent constituent being a compound which has a structure having an ink repellent property and a structure compatible with said resin constituent, and a surface roughness of said partition wall being 20-300 angstrom.

2. The printed matter according to claim 1, wherein a surface roughness of said partition wall is 50-300 angstrom.

3. The printed matter according to claim 1, wherein an optical density of said partition wall is 3.0-6.0.

4. The printed matter according to claim 1, wherein said structure having said ink repellent property of said ink repellent constituent is a fluoro alkyl group.

5. The printed matter according to claim 1, wherein said structure having said ink repellent property of said ink repellent constituent is a perfluoroalkyl group.

6. The printed matter according to claim 1, wherein said structure compatible with said resin constituent is a structure including a main chain of an alkyl group, an alkylene group or a polyvinyl alcohol group.

7. The printed matter according to claim 1, wherein said partition wall includes a black light blocking material.

8. The printed matter according to claim 7, wherein said black light blocking material of said partition wall is carbon black and a weighted average aggregate diameter of a particle size of said carbon black is 40-180 nm.

9. The printed matter according to claim 1 comprising a color filter which has a color layer including a plurality of colors and wherein said substrate is a transparent substrate and said ink film is said color layer formed by an ink which includes a color material.

10. The printed matter according to claim 1 comprising an organic electroluminescence element which has an organic luminous layer of a plurality of colors and wherein said substrate is a transparent substrate and said ink film is said organic luminous layer formed by an ink which includes an organic luminous material.
